(19) United States
(12) Patent Application Publication
(10) Pub. No.: US 2008/0205874 A1
(43) Pub. Date: Aug. 28, 2008

(54) Wide coverage image capturing and standable web phone

(76) Inventor: Landy Chen, Taipei Hsien (TW)

Correspondence Address: LANDY CHEN, 235 Chung-Ho, Box 8-24, Taipei, omitted

(21) Appl. No.: 11/709,642

(22) Filed: Feb. 23, 2007

(51) Int. Cl. G03B 17/00

(52) U.S. Cl. 396/419

(57) ABSTRACT

A wide coverage image capturing and standable web phone comprises a body having an approximately cubic shape; the body having a seat which is pivotally installed at a lower side of a back of the body; wherein the seat can be pulled out from an upper side thereof so as to be placed upon a surface; a camera base pivotally installed a lower side of the body; a camera lens assembly being embedded into the camera base; an audio system including a trumpet at an upper portion of the body and a microphone; the audio system having functions of hand-holding, hand free and incoming phone number display, and echo cancellation. A USB connector connected to the body serves for being connected to other elements. Thus web phone combines the function of phone, camera and USB connection as an integral body to increase the convenience in use.

### FIELD OF THE INVENTION

The present invention relates to web phones, and particularly to a web phone combining the function of phones, cameras and USB connections as an integral body so as to increase the convenience in use.

### BACKGROUND OF THE INVENTION

Because the communication cost is very lower than those of wired or wireless communication, web phones have become a modern way for communication. With the popularity of computers, in near future, the web phone will more and more popular.

However in many application, not only voice communication, image communication is also necessary. Thus images must be transferred massively and real time. Generally, a web cam is located at an upper end of a computer screen or a placed at a fixed position of a table. As a result, it only captures images at predetermined orientations or positions. To have a desire image, it is often that the screen must be moved or the object to be captured is moved to be within the scope of the camera. This is very inconvenient to users.

Furthermore, in hand free state, the phone often lies upon a surface so that the user must take time to find the phone. Furthermore the phone can not stand when in capturing images, users must take the phone at hand. This induces some inconvenience to users, because it is often that the user must click the keyboard for other operation, while the prior art design will affect the operation of the users.

### SUMMARY OF THE INVENTION

Accordingly, the primary object of the present invention is to provide a web phone combining the functions of phone, camera and USB connection as an integral body so as to increase the convenience in use. The image capturing orientation of the present invention is adjustable so as to have wide coverage, furthermore the camera lens is installed in the phone so that the capturing coverage of the camera can be changed easily and conveniently. Thereby the web phone of the present invention has a compact size.

To achieve above objects, the present invention provides a wide coverage image capturing and standable web phone comprising: a body having an approximately cubic shape; the body having a seat which is pivotally installed at a lower side of a back of the body; a pivotal shaft passing through a lower side of the body and two protruding ends of the pivotal shaft being inserted into the body so that the seat can pivotally rotate with respect to the body; thereby, the seat can be pulled out from an upper side thereof so as to be placed upon a surface; and thus the body can stand on the surface; a release button placed on a backside of the body and above the seat; the release button serving to release the seat so that the upper side of the seat can move out from the body; a camera base located at an upper side of the body; the camera base having an approximately cubic shape; a pivotal shaft passing through a lower side of the body and two protruding ends of the pivotal shaft being inserted into the body so that the camera base being rotatable with respect to the body through an angle; a camera lens assembly being embedded into the camera base; the computer lens assembly including at least one optical lens; the camera lens assembly being connected to other camera elements so as to form as a web cam; the cam can capture image dynamically or statically; a focus adjusting button for adjusting the focus of the camera lens assembly so as to have a clear image; an audio system including a trumpet at an upper portion of the body and a microphone; the audio system having functions of hand-holding, hand free and incoming phone number display, echo cancellation and a USB connector connected to the body for being connected to other elements.

The various objects and advantages of the present invention will be more readily understood from the following detailed description when read in conjunction with the appended drawing.

### BRIEF DESCRIPTION OF THE DRAWINGS

FIG. 1 shows a perspective view of the present invention.

FIG. 2 shows one application of the present invention, where the seat is opened.

FIG. 3 is a front view of the present invention.

FIG. 4 is a rear view of the present invention.

FIG. 5 is a right side view of the present invention.

FIG. 6 shows the left side view of the present invention.

FIG. 7 is an upper view of the present invention.

FIG. 8 is a lower view of the present invention.

FIG. 9 shows the block diagram of the present invention.

FIG. 10 is a perspective view of the present invention, where a USB connector is connected to the web phone of the present invention.

### DETAILED DESCRIPTION OF THE INVENTION

In order that those skilled in the art can further understand the present invention, a description will be provided in the following in details.

However, these descriptions and the appended drawings are only used to cause those skilled in the art to understand the objects, features, and characteristics of the present invention, but not to be used to confine the scope and spirit of the present invention defined in the appended claims.

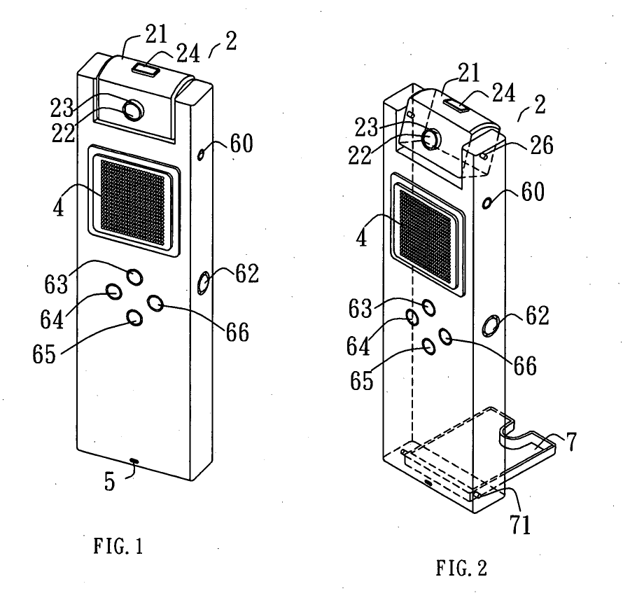

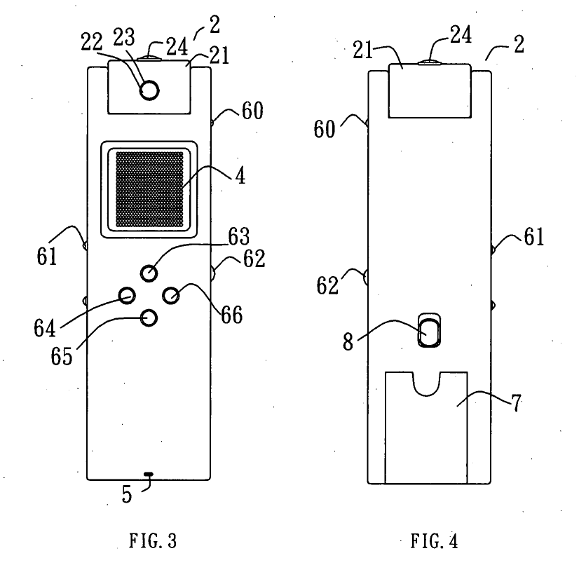

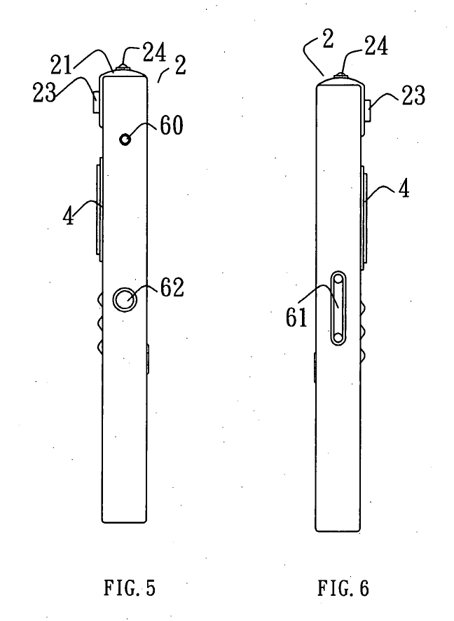

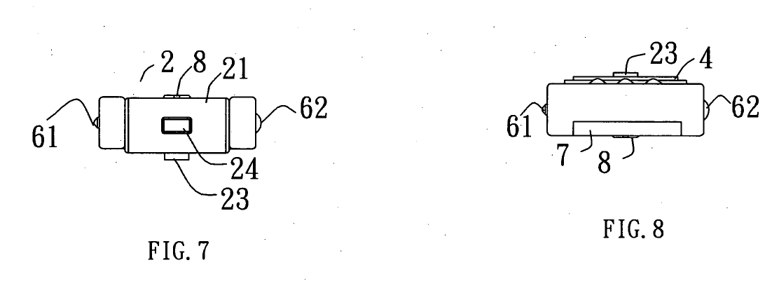

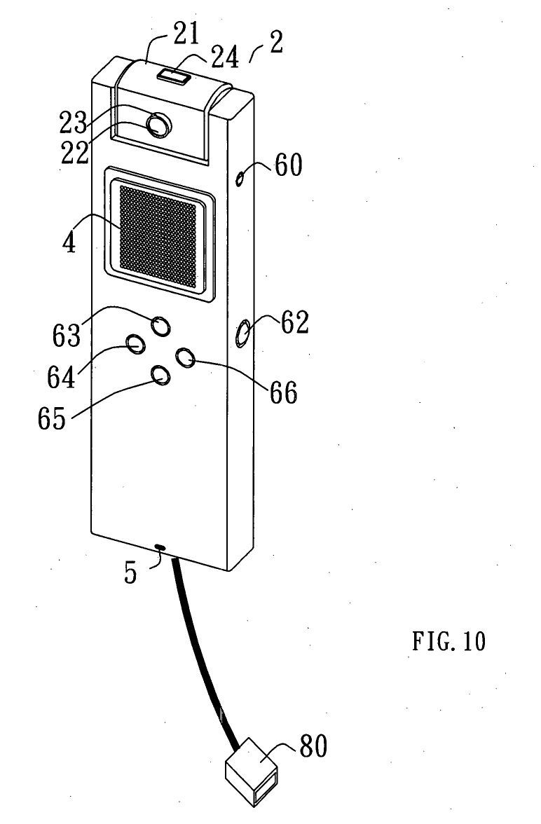

Referring to FIGS. 1 to 8, the structure of the present invention is illustrated. In FIG. 10, the USB connector of the present invention is shown, while for simplifying, in other drawings, the USB connector is hidden, however, this do not affect the user to understand the contents of the present invention.

The present invention relates to a wide coverage image capturing and standable web phone (i. e., a network phone, which performs phone communication function through networks). The web phone of the present invention has the following elements.

A main body 2 has an approximately cubic shape. The body 2 has a seat 7 which is pivotally installed at a lower side of a back of the body 2. A pivotal shaft 71 passes through a lower side of the body 2 and two protruding ends of the pivotal shaft 71 are inserted into the body 2 so that the seat 7 can pivotally rotate with respect to the body 2. In application, the seat 7 can be pulled out from an upper side thereof so as to be placed upon a surface. Thus the body 2 can stand on the surface. A release button 8 is placed on the backside of the body 2 and above the seat 7. The release button 8 serves to release the seat 7 so that the upper side of the seat 7 can move out from the body 2. Thereby the user can operate the seat 7 easily and conveniently.

A camera base 21 is located at an upper side of the body 2. The camera base 21 has an approximately cubic shape. A pivotal shaft 26 passes through a lower side of the body 2 and two protruding ends of the pivotal shaft 26 are inserted into the body 2 so that the camera base 21 can pivotally rotate with respect to the body 2 through an angle, for example, 30 degrees.

A camera lens assembly 22 is embedded into the camera base 21. The camera lens assembly 22 may be for example, a VGA computer lens assembly of 30 pixels. The computer lens assembly 22 includes at least one optical lens 200. The camera lens assembly 22 is connected to other camera elements so as to form as a web cam (web camera). The details of these elements will be described hereinafter. The web cam can capture image dynamically or statically. The image captured can be interpolated to have higher resolution. The pixels of an image may be as higher as for example 1.3M. A focus adjusting button 23 serves for adjusting the focus of the camera lens assembly 22 so as to have a clear image. Furthermore the present invention has a static image capturing button 24 for capturing a static image with the pixels of for example, 1.3 M.

The audio system of the present invention has the following elements. A trumpet 4 is at an upper portion of the body 2. The audio system of the present invention as the function of hand-holding (hand-holding the phone receiver in phone talking), hand free and incoming phone number display, etc. The echo can be cancelled. A microphone 5 has a higher accuracy, which can receive sounds emitted from a distance of at least 5 meters. Noise can be filtered.

The present invention further has the following lights and keys for assisting the operation of users easily and conveniently.

At least one LED display light 60 is installed at one lateral side of the body 2. The LED display lights 60 serves to display operation states of the present invention.

A volume control button 61 is located on one side of the body 2 for controlling sound volume at hand holding state or hand free state. In the present invention, the volume is classified as several grades, for example, 32 grades of different amplitudes. In the hand-holding communication, the volume is set at a middle level.

A silence button 62 is installed on the body 2 for actuating a silence function in communication.

A receiving button 63 serves for controlling the web phone, such as Skype web phone. The Voice internet protocol (VoIP) software is stored in a computer connected to the web phone of the present invention, which provides USB audio signals.

An interrupt button 64 serves for controlling the web phone. Other VoIP software must be interrupted, and one USB audio is retained.

A hand free button 65 is a one touch switching for switching hand holding (phone) and hand free operation.

A recorder button 66 serve for actuating a recording function of the web phone.

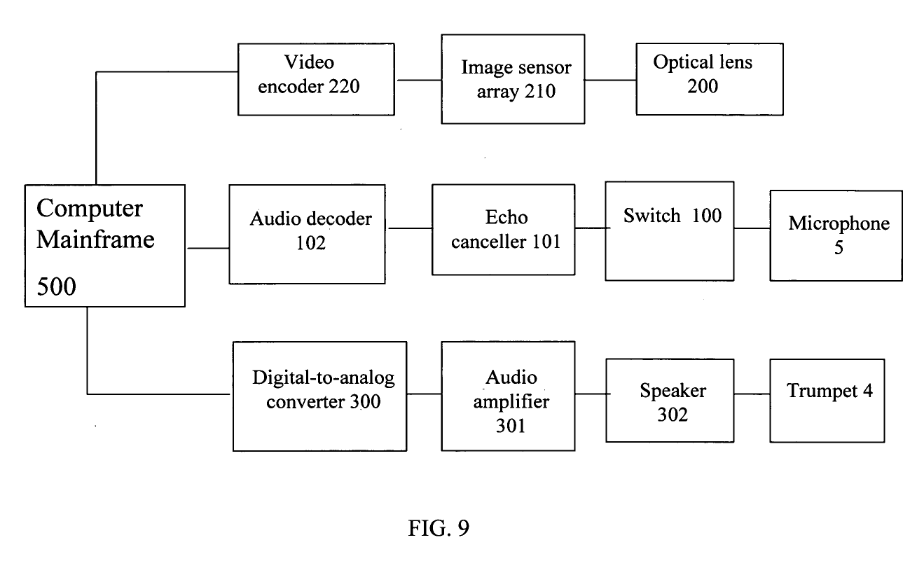

The element arrangement of the present invention will be described herein with reference to FIG. 9.

The image system of the present invention has the following elements. An optical lens 200 serves for capturing images. An image sensor array 210 (for example, a COMS array or a charge coupling device (CCD) for converting optical image into image signals. The digital signals are transferred to a video encoder 220 for converting the image signals into digital signals. These digital signals are transferred to a computer for performing image processing, such as transferred to other computer through a network.

The speech processing of the present invention will be described herein. A microphone 5 serves to receive speeches which have forms of analog signals. A switch 100 is connected to the microphone 5 for switching the states of speaking and silence. An echo canceller 101 is connected to the switch 100 for canceling echo signals. An audio decoder 102 is connected to the echo canceller 101 for converting the analog signals into digital signals which are then transferred into the computer for further processing.

Besides, speech signals from the computer can be transferred to the phone of the present invention, that is the signals are transferred to a digital-to-analog converter 300 for converting digital signals into analog signals. Then the analog signals are transferred to an audio amplifier 301 for amplifying the input audio signals. Then the amplified signals are transferred to a speaker 302 and are then outputted through the trumpet 4.

Referring to FIG. 10, it is illustrated that in the present invention, a USB connector 80 is connected to the web phone of the present invention for being connected to other elements.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A wide coverage image capturing and standable web phone comprising:
a body having an approximately cubic shape; the body having a seat which is pivotally installed at a lower side of a back of the body; a pivotal shaft passing through a lower side of the body and two protruding ends of the pivotal shaft being inserted into the body so that the seat can pivotally rotate with respect to the body; thereby, the seat can be pulled out from an upper side thereof so as to be placed upon a surface; and thus the body can stand on the surface;
a release button placed on a backside of the body and above the seat; the release button serving to release the seat so that the upper side of the seat can move out from the body;
a camera base located at an upper side of the body; the camera base having an approximately cubic shape; a pivotal shaft passing through a lower side of the body and two protruding ends of the pivotal shaft being inserted into the body so that the camera base being rotatable with respect to the body through an angle; a camera lens assembly being embedded into the camera base; the computer lens assembly including at least one optical lens; the camera lens assembly being connected to other camera elements so as to form as a web cam; the cam can capture image dynamically or statically;
a focus adjusting button for adjusting the focus of the camera lens assembly so as to have a clear image;
an audio system including a trumpet at an upper portion of the body and a microphone; the audio system having functions of hand-holding, hand free, incoming phone number display, echo cancellation and
a USB connector connected to the body for being connected to other elements.

2. The wide coverage image capturing and standable web phone as claimed in claim 1, further comprising:
at least one display light installed at one lateral side of the body for displaying operation states; and
a hand free button being a one touch switching for switching hand holding and hand free operation.

3. The wide coverage image capturing and standable web phone as claimed in claim 1, further comprising:
a volume control button at one side of the body for controlling sound volume at hand holding state or hand free state; the volume being classified as several grades of different amplifying;
a silence button installed on the body for actuating a silence function in communication;
a receiving button for controlling the web phone, such as Skype web phone; the Voice internet protocol (VoIP) software being stored in a computer end connected to the web phone, which provides USB audio signals;
an interrupt button for controlling the web phone; and
a recorder button for actuating a recording function of the web phone.

4. The wide coverage image capturing and standable web phone as claimed in claim 1, further comprising:
an image sensor array for converting optical image from the optical lens into image signals; and
a video encoder; the digital signals being transferred to the video encoder for converting the image signals into digital signals; and these digital signals being transferred to a computer for performing image processing.

5. The wide coverage image capturing and standable web phone as claimed in claim 4, further comprising:
the microphone serving to receive speeches which have forms of analog signals
a switch connected to the microphone for switching the states of speaking and silence;
an echo canceller connected to the switch for canceling echo signals; and
an audio decoder connected to the echo canceller for converting the analog signals into digital signals which are then transferred into the computer for further processing.

6. The wide coverage image capturing and standable web phone as claimed in claim 5, further comprising:
a digital to analog converter for converting digital signals from a computer into analog signals;
an amplifier; the analog signals being transferred to the audio amplifier for amplifying the input audio signals; and
a speaker; the amplified signals being transferred to the speaker and being then outputted through the trumpet.

7. The wide coverage image capturing and standable web phone as claimed in claim 1, wherein the camera lens assembly is a VGA computer lens assembly.

8. The wide coverage image capturing and standable web phone as claimed in claim 1, wherein the web phone is a Skype web phone;
